(19) United States
(12) Patent Application Publication
(10) Pub. No.: US 2023/0245212 A1
(43) Pub. Date: Aug. 3, 2023

(54) PIGGYBACK FULFILLMENT OF REPLACEMENT CONSUMABLE ITEM FOR PRINTING DEVICE USING ALTERNATIVE PROVIDER

(71) Applicant: Hewlett-Packard Development Company, L.P., Spring, TX (US)

(72) Inventors: Gabriel Scott McDaniel, Boise, ID (US); Jeffrey H. Luke, Boise, ID (US); Justin Pettingill, Boise, ID (US); Paul L. Jeran, Boise, ID (US)

(21) Appl. No.: 17/588,701

(22) Filed: Jan. 31, 2022

(51) Int. Cl. G06Q 30/06

(52) U.S. Cl. CPC G06Q 30/0635

(57) ABSTRACT

That a remaining life of a consumable item has reached a threshold at which piggyback fulfillment of a replacement consumable item is expected to result in arrival before expected continued usage of the consumable item within a printing device results in exhaustion of the remaining life is identified. In response to identifying that the remaining life has reached the threshold, the piggyback fulfillment of the replacement consumable item as part of an order for a user of the printing device using an alternative provider is initiated, rather than default fulfillment of the replacement consumable item using a primary provider being initiated.

### BACKGROUND

Printing devices can use a variety of different technologies to form images on media such as paper or to build three-dimensional (3D) objects. Such technologies include dry electrophotography (EP) and liquid EP (LEP) technologies, which may be considered as different types of laser and light-emitting diode (LED) printing technologies, as well as inkjet-printing technologies and three-dimensional (3D) printing technologies. Printing devices deposit print material, such as colorant like toner, ink (which can include other printing fluids or material as well), or 3D print material.

### BRIEF DESCRIPTION OF THE DRAWINGS

FIG. 1 is a diagram of example piggyback or default fulfillment of a replacement consumable item for a printing device.

FIG. 2 is a diagram of example stages of an order associated with piggyback fulfillment of a replacement consumable item for a printing device.

FIG. 3 is a diagram of an example graph depicting the remaining life of a consumable item for a printing device as the item is used within the printing device.

FIGS. 4A and 4B are flowcharts of an example method for piggyback fulfillment of a replacement consumable item for a printing device.

FIG. 5 is a flowchart of an example method for cancelling piggyback fulfillment of a replacement consumable item for a printing device after successful initiation.

FIG. 6 is a flowchart of an example method for default fulfillment of a replacement consumable item for a printing device.

FIG. 7 is a diagram of an example non-transitory computer-readable data storage medium storing program code that is executable to initiate piggyback fulfillment of a replacement consumable item for a printing device.

### DETAILED DESCRIPTION

As noted in the background, printing devices deposit print material to form images on media or, in the case of three-dimensional (3D) printing devices, to additively build (3D) objects. A printing device can include a cartridge of print material that the device uses for printing. As the printing device prints print jobs, print material is consumed from the cartridge. When the cartridge is empty or is running low on print material, the cartridge may be replaced with a replacement cartridge that has a fresh (e.g., full) supply of print material. A cartridge is thus one type of a consumable item that a printing device uses for printing. Other examples include fuser assemblies, developer assemblies, and so on, in the case of a laser-printing device, and fluid-ejection (e.g., inkjet) printheads in the case of a fluid-ejection (e.g., inkjet) device that employs separately replaceable printheads and fluid (e.g., ink) supplies.

The replacement cartridge may be automatically or manually ordered or shipped to an end user or other party responsible for replacing the currently installed cartridge with the replacement cartridge. For example, when the printing device is starting to run low on print material, the device may alert the user, who may then manually order a replacement cartridge. As another example, the printing device may be in communication with a computing device over a network, in accordance with a service that the end user has purchased or to which the end user has subscribed, so that a replacement cartridge is automatically shipped at the appropriate time.

The automatic shipment of a replacement cartridge or other consumable item for a printing device currently occurs as part of what is referred to herein as default fulfillment of the replacement cartridge. An exclusive order for the user, including just the replacement cartridge, is placed and shipped using a provider, which is referred to as a primary provider herein. For example, the manufacturer of the printing device or the cartridge or other entity providing the service to the user may cause the replacement cartridge to be shipped from a warehouse or store using a third party shipper, such as USPS, UPS, FedEx, DHL, OnTrac, and so on. This shipper is the provider that is used to provide default fulfillment of the replacement cartridge to the user.

As part of such default fulfillment, no other items are shipped to the user along with the replacement cartridge. For example, the primary provider that is used for default shipment may pick up the replacement cartridge from a warehouse at which the cartridge has had a shipping label affixed and/or has been boxed for shipment. As another example, the replacement cartridge after having had a shipping affixed and/or boxed for shipment may otherwise be sent to the provider instead of the provider picking up the cartridge from a warehouse. In either case, the provider delivers the replacement cartridge to the user, completing default fulfillment of the cartridge.

Default fulfillment can be environmentally and monetarily costly. From an environmental standpoint, since just the replacement cartridge is being delivered to the user—and not any other items in the same order—fossil fuel usage is greater than if the cartridge were delivered to the user along with other items as part of the same order. From a monetary standpoint, the manufacturer or other entity providing the service to the user may have to incur a shipping cost that is greater than if the cartridge were delivered to the user along with other items. Such costs are reflected in the service subscription or purchase price paid by the user to receive the service.

Techniques described herein reduce the environmental and monetary costs associated with fulfillment of a replacement consumable item for a printing device. Instead of immediately proceeding to default fulfillment of the replacement consumable item using a primary provider, what is referred to herein as piggyback fulfillment of the item using an alternative provider may instead be initiated. Examples of alternative providers include delivery service providers such as DoorDash, Instacart, UberEats, GrubHub, and PostMates, as well as Amazon Fresh, Walmart.com, among others. The alternative provider is considered an alternative provider in contrast to the primary provider associated with default fulfillment.

A user may have created but not yet have placed an order with an alternative provider, or may be expected to create and place the order with the alternative provider. The replacement consumable item is then added to the order if already created or when the order is created. The consumable item is thus fulfilled along with one or multiple other items as part of the same order for the user using the alternative provider. Piggyback fulfillment therefore results in fulfillment of the replacement consumable item piggybacking on an order that the user has already or is expected to place with the alternative provider.

Environmental costs are lessened via piggyback fulfillment. Whereas default fulfillment results in the replacement consumable item being fulfilled as part of an exclusive order for the user including no other items, piggyback fulfillment leverages an order that already does or will include one or multiple other items. The marginal environmental cost in adding the replacement consumable item to an order including one or multiple other items is lower than the environmental cost in placing and shipping an exclusive order including just the replacement consumable item.

Monetary costs may similarly be lessened via piggyback fulfillment. The manufacturer or other entity providing the service may be able to add the replacement consumable item to an existing order or an order expected to be created for the user with an alternative provider at a cost less than that of placing and shipping an exclusive order with a primary provider, as is the case with default fulfillment. This in turn may result in a lower service subscription or purchase price that is borne by the user.

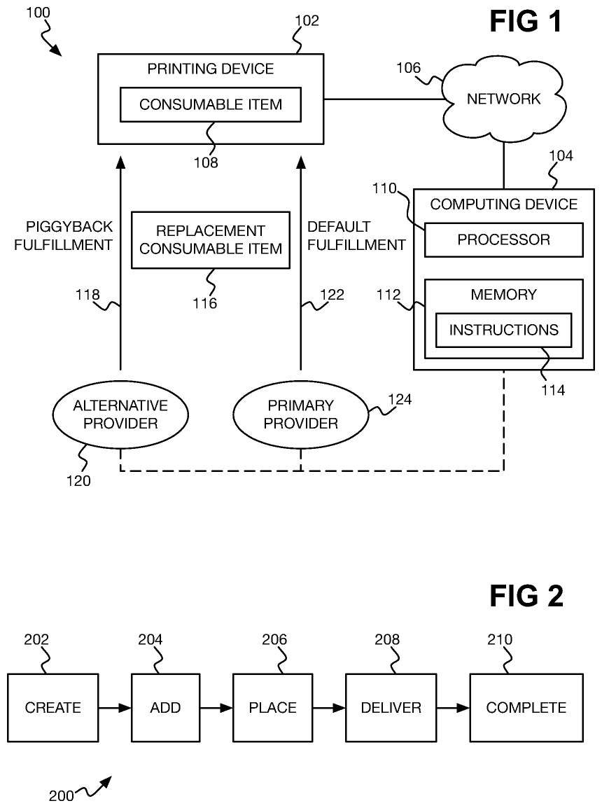

FIG. 1 shows an example system 100 including a printing device 102 and a computing device 104 communicatively connected over a network 106, which may be or include the Internet. The printing device 102 may be a standalone printer or another type of printing device, such as an all-in-one (AIO) device or a multifunction device (MFD) that in addition to including printing functionality includes other functionality, such as scanning, copying, and/or faxing functionality. The printing device 102 includes a consumable item 108 having a remaining life that is depleted as the device 102 uses the item 108 for printing.

As the printing device 102 uses the consumable item 108 for printing, or periodically, the device 102 may report such usage to the computing device 104 over the network 106. The printing device 102 may report how much of the life of the consumable item 108 has been used since the last time the printing device 102 reported to the computing device 104. Additionally or instead, the printing device 102 may report the remaining life of the consumable item 108 to the computing device 104. If the printing device 102 does not report the remaining life, the computing device 104 is able to determine the remaining life of the consumable item 108 based on the information that the printing device 102 does report.

The computing device 104 may be a server computer and may be considered a cloud computing device providing a service to the user of the printing device 102. The computing device 104 includes a processor 110 and a memory 112 storing instructions 114, such as in the form of program code, executable by the processor 110. The computing device 104 can include other components in addition to those depicted in the figure. Execution of the instructions 114 by the processor 110 from the memory 112 can result in the computing device 104 performing the methods and processing described later in the detailed description.

The computing device 104 may be maintained by the manufacturer of the printing device 102 and/or the consumable item 108, or by another entity on behalf of the manufacturer, for instance. The user of the printing device 102 may subscribe to or have purchased a service by which a replacement consumable item 116 is automatically delivered to the user by the manufacturer or other entity when the remaining life of the consumable item 108 is sufficiently low. As part of this service, the replacement consumable item 116 may be automatically delivered to the user before the remaining life of the consumable item 108 has been depleted, so that the user is not in a situation in which he or she is unable to print using the printing device 102.

The computing device 104, via execution of the instructions 114 by the processor 110 from the memory 112, arranges for one of two different types of fulfillment of the replacement consumable item 116 as part of the service. Piggyback fulfillment 118 using an alternative provider 120 may first be attempted to be initiated. If the user has already created but has not yet placed an order for one or more other items with the alternative provider 120, or is expected to create and place such an order, then the replacement consumable item 116 may be added as part of the order. The ordered is fulfilled by the alternative provider 120 delivering the replacement consumable item 116 as part of the order to the user of the printing device 102.

If the user has not or is not expected to create an order for one or more other items with the alternative provider 120, then default fulfillment 122 using a primary provider 124 may instead be initiated. An exclusive order for just the replacement consumable item 116, without any other item, is created and placed. The order is fulfilled by the primary provider 124 in that the primary provider 124 delivers the replacement consumable item 116 to the user of the printing device 102. Default fulfillment 122 may also be initiated even after piggyback fulfillment 118 is initiated if piggyback fulfillment 118 will not be successful, as is described in detail later in the detailed description.

FIG. 2 shows example stages 202, 204, 206, 208, and 210 of an order 200 associated with piggyback fulfillment 118 of the replacement consumable item 116 to the user of the printing device 102 using the alternative provider 120. The first stage 202 involves creation of the order 200. For example, an order 200 may be created that includes one or multiple items other than the replacement consumable item 116. The second stage 204 involves adding the replacement consumable item 116 to the created order 200. The third stage 206 involves placing the order 200 with the alternative provider 120.

Placement of the order 200 can be successful or unsuccessful as to the replacement consumable item 116. Order placement is successful as to the replacement consumable item 116 if the consumable item 116 is in stock and available for delivery when the order 200 is placed. For example, the replacement consumable item 116 may have been in stock when added to the order 200, but when the order 200 is actually placed—such that the item 116 is reserved for the user of the printing device 102—the consumable item 116 may no longer be in stock. In this case, order placement is unsuccessful as to the replacement consumable item 116.

Order placement is also unsuccessful as to the replacement consumable item 116 in other respects as well. First, if the order 200 has not even been initially created in the first stage 202, then placement of the order 200 does not occur and therefore order placement is unsuccessful. Second, if the order 200 has been created but the replacement consumable item 116 has not been added to the order 200 in the second stage 204, then placement of the order 200 as to the replacement consumable item 116 is similarly unsuccessful since the consumable item 116 is not part of the placed order 200.

The fourth stage 208 is delivery of the order 200, including the replacement consumable item 116 and one or multiple other items, to the user of the printing device 102 via the alternative provider 120. That is, once the order 200 has been placed, the alternative provider 120 arranges for delivery of the order 200 to the user of the printing device 102. Once the alternative provider 120 has delivered the order 200 to the user, such that the user has received the items that were successfully placed as part the order 200, the fifth stage 208 is the completion of the 200.

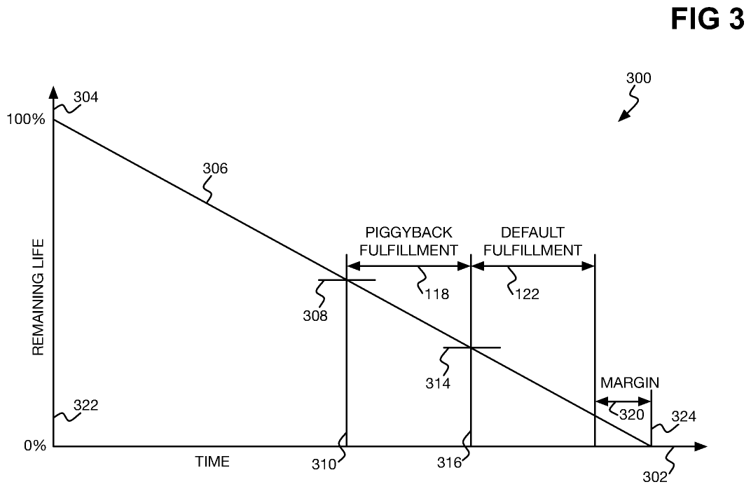

FIG. 3 shows an example graph 300 depicting the remaining life of the consumable item 108 within the printing device 102 over time in idealized form. The x-axis 302 denotes time, whereas the y-axis 304 denotes the remaining life of the consumable item 108 as a percentage. When the consumable item 108 is first installed within the printing device 102 at time 322, the item 108 has a remaining life of 100%. As the printing device 102 uses the consumable item 108 for printing, the remaining life is depleted over time until the item 108 has a remaining life of 0% at time 324.

The line 306 therefore indicates the remaining life of the consumable item 108 within the printing device 102 over time. The line 306 is linear, and thus represents idealized usage of the consumable item 108 within the printing device 102 for printing. In actuality, the line 306 is unlikely to be linear, but for descriptive and illustrative clarity and convenience is shown as such in the figure. In general, the line 306 may have multiple segments that are each curved or straight.

Piggyback fulfillment 118 and default fulfillment 122 are identified in the graph 300. Piggyback fulfillment 118 is initiated at time 310, which corresponds to the remaining life of the consumable item 108 reaching a first, piggyback threshold 308. At the piggyback threshold 308, piggyback fulfillment 118 of the replacement consumable item 116, if initiated, is expected to result in arrival of the consumable item 116 at the location of the user and/or the printing device 102 before expected continued usage of the consumable item 108 within the device 102 results in exhaustion of its remaining life. More generally, the piggyback threshold 308 is in advance of the last time at which piggyback fulfillment 118 can be initiated to result in expected arrival of the replacement consumable item 116 before the remaining life of the consumable item 108 is exhausted.

Default fulfillment 122 is initiated at time 316, which corresponds to the remaining life of the consumable item 108 reaching a second, default threshold 314. At the default threshold 314, default fulfillment 122, if initiated, is expected to result in arrival of the consumable item 116 before expected continued usage of the consumable item 108 within the device 102 results in exhaustion of its remaining life. Because the time 324 at which the consumable item 108 may not be able to be accurately predicted, and/or because the length of time for default fulfillment 122 can unexpectedly lengthen, a margin 320 is added. Therefore, default fulfillment 122 is ultimately expected to result in arrival of the replacement consumable item 116 by a time period equal to the margin 320 before complete exhaustion of the remaining life of the consumable item 108.

The piggyback threshold 308 occurs at time 310 before time 316 at which the default threshold 314 occurs. Stated another way, the piggyback threshold 308 is greater than the default threshold 314. Piggyback fulfillment 118 is therefore initiated before default fulfillment 122 is initiated. If when the remaining life of the consumable item 108 reaches the default threshold 314, the order 200 for the replacement consumable item 116 has not been successfully placed as to the consumable item 116, then piggyback fulfillment 118 is cancelled, and default fulfillment 122 is instead initiated. However, if when the remaining life reaches the default threshold 314, the order has been successfully placed as to the replacement consumable item 116, then default fulfillment 122 is not initiated.

Therefore, default fulfillment 122 is performed just if piggyback fulfillment 118 is ultimately unsuccessful. Piggyback fulfillment 118 may not have even been initiated if an alternative provider 120 having the replacement consumable item 116 in stock cannot be identified. By comparison, if piggyback fulfillment 118 is (or will likely be) successful, then default fulfillment 122 is not initiated. That is, so long as the order 200 has been successfully placed with the alternative provider 120 that includes the replacement consumable item 116, then default fulfillment 122 may not be initiated. In such an implementation, in other words, the order 200 may not yet have been delivered to the user, but successful placement of the order 200 as to the replacement consumable item 116 is a strong indicator that piggyback fulfillment 118 will more than likely be successful.

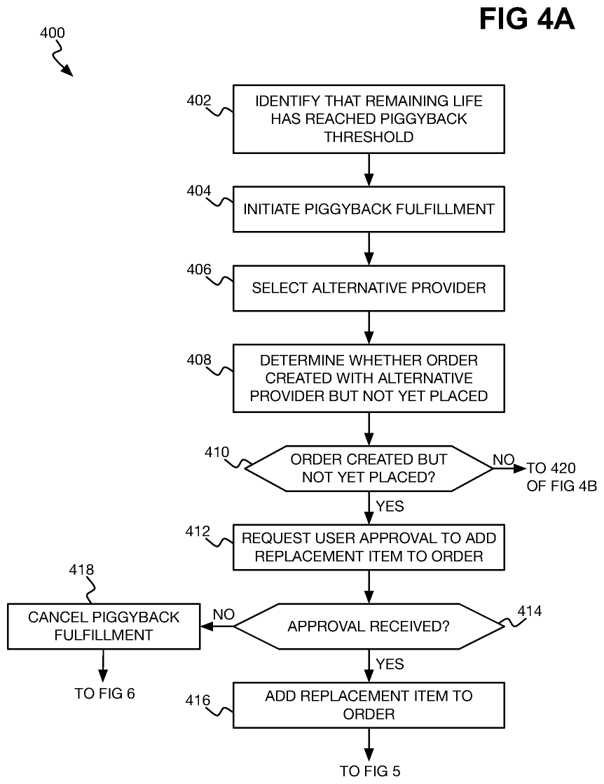

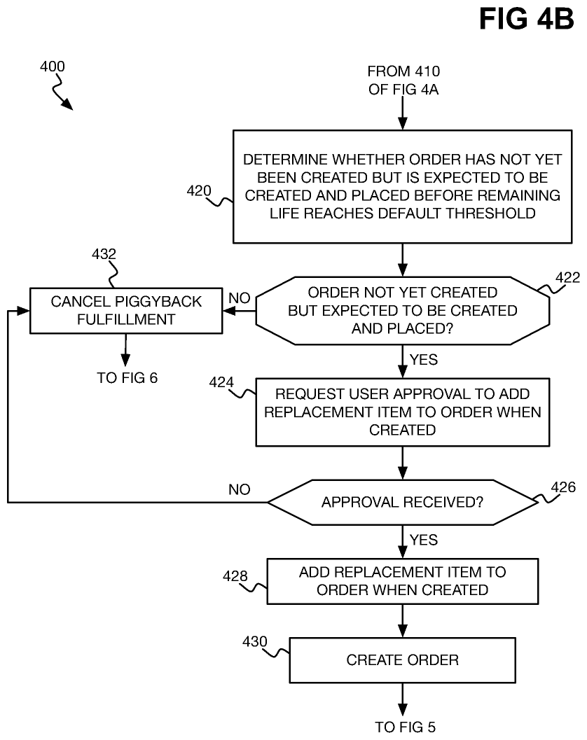

FIGS. 4A and 4B show an example method 400 for piggyback fulfillment 118 of a replacement consumable item 116. The method 400 can be implemented as program code stored on a non-transitory computer-readable data storage medium and executable by a processor. For instance, the method 400 can be implemented as the instructions 114 stored on the memory 112 of the computing device 104 and executed by the processor 110 of the device 104.

The remaining life of the consumable item 108 currently installed within the printing device 102 is identified as having reached the piggyback threshold 308 (402). In response, piggyback fulfillment 118 of the replacement consumable item 116 is initiated (404). An alternative provider 120 to use for such piggyback fulfillment 118 can be selected (406) from a number of providers. The alternative provider 120 may be selected as one that has the replacement consumable item 116 in stock, for instance, and/or as one with which the user of the printing device 102 has created an order or has previously created orders.

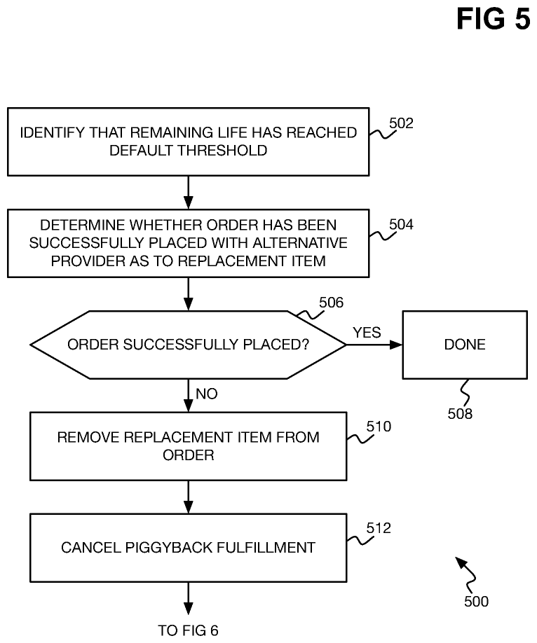

Whether the user has already created but has not yet placed an order 200 with the selected alternative provider 120, including one or multiple items other than the replacement consumable item 116, is determined (408). If the user has already created but has not yet placed such an order 200 (410), then the user may be requested to provide approval to add the replacement consumable item 116 to the order 200 (412). If the user provides such approval (414), then the replacement consumable item 116 is added to the already created order 200 (416), and the method 400 proceeds to FIG. 5. In another implementation, the replacement consumable item 116 may be automatically added to the existing order 200, without first receiving user approval.

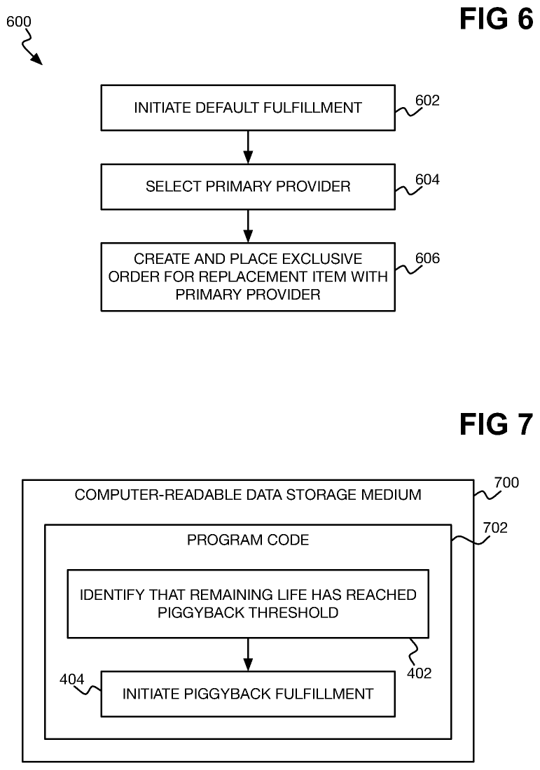

If the user does not approve adding the replacement consumable item 116 to the order 200 with the alternative provider 120 (414), however, then piggyback fulfillment 118 of the replacement consumable item 116 is cancelled (418). The method 400 proceeds to FIG. 6 once the remaining life of the consumable item 108 reaches the default threshold 314, to initiate default fulfillment 122. However, if the order 200 has not even yet been created (410), piggyback fulfillment 118 may still yet successfully occur.

Specifically, if the order 200 has not even yet been created (410), whether the order 200 is expected to be created and placed for one or multiple items other than the replacement consumable item 116 before the remaining life of the consumable item 108 reaches the default threshold 314 is determined (420). This determination can be based on past orders for the user with the alternative provider 120. For instance, machine learning may be used to determine that an order 200 for the user is likely expected to be created and placed before the remaining life reaches the default threshold 314.

As a concrete example, the user of the printing device 102 may regularly order groceries with an alternative provider 120 that also has the replacement consumable item 116 in inventory. The user may be in-between orders, but based on the user's past orders, another order 200 to which the replacement consumable item 116 can be added is expected to be created and placed before the remaining life of the consumable item 108 reaches the default threshold 314. As another concrete example, the user may have an ongoing subscription for items other than the replacement consumable item 116 with the alternative provider 120, where the next order 200 will be created and placed as part of this subscription before the remaining life reaches the default threshold 314.

If the order 200 has not yet been created but is expected to be created and placed before the remaining life of the consumable item 108 reaches the default threshold 314 (422), then the user may be requested to provide approval to add the replacement consumable item 116 to the order 200 when it is placed (424). If the user provides such approval (426), then the replacement consumable item 116 is added to the order 200 when the order 200 is placed (428), and the method 400 proceeds to FIG. 5. In another implementation, the replacement consumable item 116 may be automatically added to the order 200 when the order 200 is placed, without first receiving user approval. The order 200 may also be explicitly created (430), on the assumption that one or multiple other items will be added to the order 200.

If the user does not approve adding the replacement consumable item 116 to the order 200 with the alternative provider 120 when the order 200 is created (426), however, then piggyback fulfillment 118 of the replacement consumable item 116 is cancelled (432). The method 400 proceeds to FIG. 6 once the remaining life of the consumable item 108 reaches the default threshold 314, to initiate default fulfillment 122. Ultimately, then, in the method 400, piggyback fulfillment 118 can occur either if an order 200 for the user has been created but not yet placed, or if an order 200 for the user has not been created but is expected to be created and placed.

FIG. 5 shows an example method 500 for cancelling piggyback fulfillment 118 of the replacement consumable item 116 after successful initiation. That is, the method 500 is performed after piggyback fulfillment 118 has been successfully initiated with the addition of the replacement consumable item 116 to an already created order 200 in part 416 of FIG. 4A or to an order 200 when created in part 428 of FIG. 4B. Like the method 400 of FIGS. 4A and 4B, the method 500 can be implemented as program code stored on a non-transitory computer-readable data storage medium and executable by a processor.

The remaining life of the consumable item 108 installed within the printing device 102 is identified as having reached the default threshold 314 (502). In response, at this time 316, whether the order 200 with the alternative provider 120 has been successfully placed as to the replacement consumable item 116 is determined (504). As noted, the order 200 is considered as having been successfully placed as to the replacement consumable item 116 if the order 200 includes the replacement consumable item 116 and the order 200 has in fact been created and placed.

The order 200 may be unsuccessful as to the replacement consumable item 116 if it has not yet been placed by time 316 when the remaining life has reached the default threshold 314. The order 200 may be unsuccessful as to the replacement consumable item 116 if it has been placed by time 316, but does not include the replacement consumable item 116. As noted, the replacement consumable item 116 may have gone out of stock between the time when the consumable item 116 was added to the order 200 and when the order 200 was placed.

If the order 200 has been successfully placed as to the replacement consumable item 506 (506), then the method 500 is finished (508). That is, it is assumed in this implementation that because the order 200 has been successfully placed, the alternative provider 120 will deliver the replacement consumable item 116 to the user of the printing device 102 before the remaining life of the consumable item 108 is exhausted. Although piggyback fulfillment 118 has not been completed, it is expected to be completed successfully before the remaining life is exhausted.

However, if the order 200 has not been successfully placed as to the replacement consumable item 116 (506), the replacement consumable item 116 is removed from the order 200 (510) if the order 200 has not yet been placed at all (510). Piggyback fulfillment 118 of the replacement consumable item 116 is accordingly cancelled (512). The method 500 then proceeds to FIG. 6 to immediately initiate default fulfillment 122 instead.

As a concrete example, the order 200 may not yet have been placed by time 316 when the remaining life of the consumable item 108 has reached the default threshold 314. Even though the replacement consumable item 116 may be in stock with the alternative provider 120 and the order 200 likely to be ultimately delivered to the user of the printing device 102 before the remaining life of the consumable item 108 is exhausted, because the order 200 has not yet been placed by time 316, piggyback fulfillment 118 is nevertheless cancelled. This is because in this scenario piggyback fulfillment 118 may be considered riskier than default fulfillment 122 in timely arrival of the replacement consumable item 116 at the location of the user and/or the printing device 102.

That is, to ensure that the user will definitively receive the replacement consumable item 116 before the consumable item 108 is exhausted of its remaining life, even if it is possible—or even likely—that piggyback fulfillment 118 will still be successfully completed before the exhaustion of the remaining life, piggyback fulfillment 118 is nevertheless cancelled in this scenario at time 316. This is because at time 316, default fulfillment 122 has to be initiated to ensure that default fulfilment 122 will be successfully completed before the remaining life of the consumable item 108 is exhausted. If the order 200 has not yet been placed at time 316, to better guarantee timely arrival of the replacement consumable item 116, default fulfillment 122 is instead employed.

FIG. 6 shows an example method 600 for default fulfillment 122 of the replacement consumable item 116. The method 600 is performed when the remaining life of the consumable item 108 currently installed within the printing device 102 reaches the default threshold 314, following cancellation of piggyback fulfillment 118 in part 418 of FIG. 4A and part 432 of FIG. 4B. The method 600 is also performed after piggyback fulfillment 118 is cancelled in part 512 of FIG. 5 after the remaining life has reached the default threshold 314. Like the method 400 of FIGS. 4A and 4B, the method 600 can be implemented as program code stored on a non-transitory computer-readable data storage medium and executable by a processor.

Default fulfillment 122 of the replacement consumable item 116 is thus initiated (602). A primary provider 124 to use for such default fulfillment can be selected (604) from a number of providers. The primary provider 124 may be selected as one that can deliver the replacement consumable item 116 to the user prior to the exhaustion of the remaining life of the consumable item 108, as well as based on cost and other factors. In one implementation, the primary provider 124 that is selected can even be an alternative provider 120.

The difference between an alternative provider 120 being used for default fulfillment 122 as opposed to piggyback fulfillment 118 is that in the former, the order 200 that is created and placed for the replacement consumable item 116 includes one or multiple other items as well. By comparison, in the latter, the order 200 is an exclusive order for and that includes just the replacement consumable item 116. Therefore, an exclusive order is created and placed for the replacement consumable item 116 with the selected primary provider 124 to achieve default fulfillment 122 (606), where in the case in which the primary provider 124 is a shipper this means that the provider 124 delivers the consumable item 116.

FIG. 7 shows a non-transitory computer-readable data storage medium 700 storing program code 702 executable by a processor. For example, the processor may be the processor 110 of the computing device 104, The program code 702 may be in the form of or include the instructions 114, and the computer-readable data storage medium 700 may be the memory 112. The program code 702 is executable by the processor to perform processing.

The processing includes identifying that a remaining life of a consumable item 108 has reached a threshold 308 at which piggyback fulfillment 118 of a replacement consumable item 116 is expected to result in arrival before expected continued usage of the consumable item 108 within a printing device 102 results in exhaustion of the remaining life (402). The processing includes, in response to identifying that the remaining life has reached the threshold 308, initiating piggyback fulfillment 118 of the replacement consumable item 116 as part of an order 200 for a user of the printing device 102 using an alternative provider 120 (404). Piggyback fulfillment 118 is thus initiated rather than default fulfillment 122 of the replacement consumable item 116 using a primary provider 124.

Techniques have been described for piggyback fulfillment of a replacement consumable item for a printing device using an alternative provider. Such techniques can lessen environmental and monetary costs associated with replacement consumable item fulfillment. Whereas default fulfillment of the replacement consumable item using a primary provider can entail shipment an exclusive order including just the replacement consumable item, piggyback fulfillment using an alternative provider entails delivery of an order including the replacement consumable item as well as one or multiple other items.

We claim:

1. A non-transitory computer-readable data storage medium storing program code executable by a processor to perform processing comprising:
identifying that a remaining life of a consumable item has reached a threshold at which piggyback fulfillment of a replacement consumable item is expected to result in arrival before expected continued usage of the consumable item within a printing device results in exhaustion of the remaining life; and
in response to identifying that the remaining life has reached the threshold, initiating the piggyback fulfillment of the replacement consumable item as part of an order for a user of the printing device using an alternative provider, rather than initiating default fulfillment of the replacement consumable item using a primary provider.

2. The non-transitory computer-readable data storage medium of claim 1, wherein the piggyback fulfillment of the replacement consumable item results in the replacement consumable item being fulfilled along with one or multiple other items of the order for the user using the alternative provider,
and wherein the default fulfillment of the replacement consumable item results in the replacement consumable item being fulfilled as part of an exclusive order for the user, without any other item, using the default provider.

3. The non-transitory computer-readable data storage medium of claim 1, wherein the threshold is a first threshold, and the processing further comprises:
after initiating the piggyback fulfillment of the replacement consumable item, identifying that the remaining life has reached a second threshold at which the default fulfillment of the replacement consumable item is expected to result in the arrival before the expected continued usage of the consumable item within the printing device results in the exhaustion of the remaining life;
in response to identifying that the remaining life has reached the second threshold, determining that the order using the alternative provider has not yet been successfully placed as to the replacement consumable item; and
in response to determining that the order using the alternative provider has not yet been successfully placed as to the replacement consumable item, removing the replacement consumable item from the order, cancelling the piggyback fulfillment of the replacement consumable item using the alternative provider, and instead initiating the default fulfillment of the replacement consumable item using the primary provider.

4. The non-transitory computer-readable data storage medium of claim 3, wherein the processing further comprises:
selecting the primary provider from a plurality of providers that are able to fulfill the replacement consumable item to result in the arrival before the expected continued usage of the consumable item within the printing device results in the exhaustion of the remaining life.

5. The non-transitory computer-readable data storage medium of claim 4, wherein the plurality of providers from which the primary provider is selected includes the alternative provider.

6. The non-transitory computer-readable data storage medium of claim 1, wherein the processing further comprises:
determining that the order has been created with the alternative provider but has not yet been placed; and
in response to determining that the order has been created with the alternative provider but has not yet been placed, adding the replacement consumable item to the order to initiate the piggyback fulfillment of the replacement consumable item using the alternative provider.

7. The non-transitory computer-readable data storage medium of claim 6, wherein the processing further comprises:
in response to determining that the order has been created with the alternative provider but has not yet been placed, requesting the user to approve adding the replacement consumable item to the order;
in response to receiving approval from the user to add the replacement consumable item to the order, proceeding to add the replacement consumable item to the order to initiate the piggyback fulfillment of the replacement consumable item using the alternative provider; and
in response to not receiving the approval from the user to add the replacement consumable item to the order, not proceeding to add the replacement consumable item to the order to initiate the piggyback fulfillment of the replacement consumable item using the alternative provider, and instead initiating the default fulfillment of the replacement consumable item using the primary provider.

8. The non-transitory computer-readable data storage medium of claim 1, wherein the threshold is a first threshold, and the processing further comprises:
determining that the order has not yet been created but is expected to be created with the alternative provider and placed before the expected continued usage results in the remaining life reaching a second threshold at which the default fulfillment is expected to result in the arrival before the expected continued usage results in the exhaustion of the remaining life;
in response to determining that the order has not yet been created but is expected to be created with the alternative providing and placed before the expected continued usage results in the remaining life reaching the second threshold, adding the replacement consumable item to the order when the order is created to initiate the piggyback fulfillment of the replacement consumable item using the alternative provider.

9. The non-transitory computer-readable data storage medium of claim 8, wherein the processing further comprises:
in response to determining that the order has not yet been created but is expected to be created with the alternative provider and placed before the expected continued usage results in the remaining life reaching the second threshold, creating the order.

10. The non-transitory computer-readable data storage medium of claim 8, wherein the processing further comprises:
in response to determining that the order has not yet been created but is expected to be created with the alternative provider and placed before the expected continued usage results in the remaining life reaching the second threshold, requesting the user to approve adding the replacement consumable item to the order when the order is created;
in response to receiving approval from the user to add the replacement consumable item to the order when the order is created, proceeding to add the replacement consumable item to the order when the order is created to initiate the piggyback fulfillment of the replacement consumable item using the alternative provider; and
in response to not receiving the approval from the user to add the replacement consumable item to the order when the order is created, not proceeding to add the replacement consumable item to the order to initiate the piggyback fulfillment of the replacement consumable item using the alternative provider, and instead initiating the default fulfillment of the replacement consumable item using the primary provider.

11. The non-transitory computer-readable data storage medium of claim 8, wherein determining that the order has not yet been created but is expected to be created with the alternative provider and placed before the expected continued usage results in the remaining life reaching the second threshold is based on past orders for the user with the alternative provider.

12. The non-transitory computer-readable data storage medium of claim 11, wherein determining that the order has not yet been created but is expected to be created with the alternative provider and placed before the expected continued usage results in the remaining life reaching the second threshold comprises using machine learning.

13. The non-transitory computer-readable data storage medium of claim 1, wherein the processing further comprises:
selecting the alternative provider from a plurality of providers that are able to fulfill the replacement consumable item to result in the arrival before the expected continued usage of the consumable item within the printing device results in the exhaustion of the remaining life.

14. A method comprising:
identifying, by a processor, that a remaining life of a consumable item has reached a threshold at which piggyback fulfillment of a replacement consumable item is expected to result in arrival before expected continued usage of the consumable item within a printing device results in exhaustion of the remaining life; and
in response to identifying that the remaining life has reached the threshold, initiating, by the processor, the piggyback fulfillment of the replacement consumable item as part of an order for a user of the printing device using an alternative provider, rather than initiating default fulfillment of the replacement consumable item using a primary provider,
wherein the piggyback fulfillment of the replacement consumable item results in the replacement consumable item being fulfilled along with one or multiple other items of the order for the user using the alternative provider.

15. A computing system comprising:
a processor; and
a memory storing instructions executable by the processor to:
identify that a remaining life of a consumable item has reached a first threshold at which piggyback fulfillment of a replacement consumable item is expected to result in arrival before expected continued usage of the consumable item within a printing device results in exhaustion of the remaining life;
in response to identifying that the remaining life has reached the first threshold, initiate the piggyback fulfillment of the replacement consumable item as part of an order for a user of the printing device using an alternative provider;
after initiating the piggyback fulfillment of the replacement consumable item, identify whether the remaining life has reached a second threshold at which default fulfillment of the replacement consumable item using a primary provider is expected to result in the arrival before the expected continued usage results in the exhaustion of the remaining life;
in response to identifying that the remaining life has reached the second threshold, determine whether the order using the alternative provider has not yet been successfully placed as to the replacement consumable item; and
in response to determining that the order using the alternative provider has not yet been successfully placed as to the replacement consumable item, remove the replacement consumable item from the order, cancel the piggyback fulfillment of the replacement consumable item using the alternative provider, and instead initiate the default fulfillment of the replacement consumable item using the primary provider.
